(19) United States
(12) Patent Application Publication
(10) Pub. No.: US 2026/0055251 A1
(43) Pub. Date: Feb. 26, 2026

(54) METHOD FOR PREPARING HYDROPHOBIC MELAMINE RESIN FOAM, AND ITS PRODUCTS AND APPLICATIONS

(71) Applicant: FoamTech (Zhejiang) New Materials Co., Ltd, Yiwu (CN)

(72) Inventors: Yangyang Li, Yiwu (CN); Xuezi Fan, Yiwu (CN)

(21) Appl. No.: 18/813,039

(22) Filed: Aug. 23, 2024

(51) Int. Cl. C08J 9/42; B01J 20/26; B01J 20/28; B01J 20/30; B01J 20/32; C02F 1/28; C02F 101/32; C08G 73/06

(52) U.S. Cl. CPC C08J 9/42; B01J 20/262; B01J 20/267; B01J 20/28045; B01J 20/3071; B01J 20/3078; B01J 20/3212; B01J 20/3221; B01J 20/3236; B01J 20/3282; B01J 20/3285; C02F 1/288; C08G 73/0644; C02F 1/285; C02F 2101/32; C08J 2379/04

(57) ABSTRACT

The invention relates to the field of functional materials technology, specifically to a preparation method, product, and application of hydrophobic melamine resin foam. The preparation method of hydrophobic melamine resin foam includes the following steps: Vacuum-impregnate the melamine resin foam with a solution of poly(dimethyl diallyl ammonium chloride). Subsequently, immerse the cationic-coated melamine resin foam in a sodium polyacrylate solution. Next, immerse the anionic-coated melamine resin foam in a titanium dioxide mixed solution for cross-linking. After cross-linking, immerse the melamine resin foam in a solution of tridecafluoro-octyl triethoxysilane. After impregnation, dry the foam to obtain hydrophobic melamine resin foam. The preparation method of the invention is simple, cost-effective, and easy to scale up for industrial applications. The hydrophobic melamine resin foam prepared using this method can achieve a hydrophobic contact angle of up to 150° and exhibits excellent oil absorption performance.

### TECHNICAL FIELD

The invention relates to the field of functional materials technology, particularly to a method for preparing hydrophobic melamine resin foam, and its products and applications.

### BACKGROUND

Oil-containing wastewater refers to wastewater discharged from industrial processes containing oil substances, including natural petroleum, petroleum products, tar and its fractions, as well as edible animal and plant oils and fats. In terms of water pollution, petroleum and tar are the primary concerns. The sources of oil-containing wastewater are very diverse. In addition to large amounts of oil-containing wastewater discharged from petroleum extraction and processing industries, other sources include thermal processing of solid fuels, washing wastewater from the textile industry, tanning wastewater from light industry, emulsions from railways and transportation industries, slaughterhouses, food processing, and cutting fluids in the mechanical industry. Among these, wastewater from the petroleum industry and solid fuel thermal processing industry are the major sources.

The hazards of oil-containing wastewater mainly manifest in the serious impacts on soil, plants, and water bodies:
1. Oil-containing wastewater can infiltrate soil pores and form an oil film, leading to blockage, which prevents air and moisture from penetrating the soil, hindering crop growth and even causing crops to die.
2. When oil-containing wastewater is discharged into water bodies, it creates an oil film on the water surface, obstructing the transfer of oxygen from the air to the water, which can lead to the death of aquatic life due to severe oxygen deficiency.
3. Discharging oil-containing wastewater into urban sewage pipelines adversely affects the pipelines, auxiliary equipment, and municipal sewage treatment plants. When using biological treatment methods, the oil and tar content is generally required not to exceed 50 mg/L.

Current treatment methods for oil-containing wastewater include salting-out methods, flocculant-based oil removal, electro-flocculation oil removal, coarse granulation oil removal, adsorption methods, flotation methods, and membrane separation methods. Among these, adsorption methods are most widely used due to their simplicity, good mechanical properties, and reusability. In adsorption methods, foam is commonly used as the substrate material. Melamine resin foam is particularly widely used due to its high porosity, good mechanical properties, widespread availability, and low cost. However, melamine resin foam, due to its hydrophilic and lipophilic nature, cannot selectively adsorb grease from water. Therefore, hydrophobic modification of melamine resin foam is necessary for its use in oil-containing wastewater adsorption treatment. Common hydrophobic modification methods involve in-situ growth of modifying materials on the substrate, changing the substrate's roughness and surface energy. For example, metal oxides and nanocrystals are grown in situ on the foam framework in solution, and the modifying materials are deposited and grown on the foam surface using chemical vapor deposition. However, this method has drawbacks including time-consuming and energy-intensive modification processes, complexity, and high costs.

### SUMMARY

Based on the above content, the invention provides a method for preparing hydrophobic melamine resin foam, as well as its products and applications.

To achieve the above objectives, the invention provides the following solution:

Technical Solution 1: A method for preparing hydrophobic melamine resin foam, comprising the following steps:

Step 1: Vacuum-impregnate melamine resin foam in a poly(dimethyl diallyl ammonium chloride) solution to obtain melamine resin foam with a cationic membrane coating.

Step 2: Immerse the melamine resin foam with the cationic membrane coating in a poly(sodium acrylate) solution to obtain melamine resin foam with an anionic membrane coating.

Step 3: Immerse the melamine resin foam with the anionic membrane coating in a titanium dioxide mixed solution for cross-linking, resulting in cross-linked melamine resin foam.

Step 4: Immerse the cross-linked melamine resin foam in a trifluorooctyltriethoxysilane solution, and after impregnation, dry it to obtain the hydrophobic melamine resin foam.

In some embodiments of the invention, prior to Step 1, the method further includes washing the melamine resin foam with deionized water and drying it at 40-60° C. for 6-8 hours.

In some embodiments of the invention, in Step 1, the poly(dimethyl diallyl ammonium chloride) solution has a concentration of 5 mol/L; the vacuum impregnation time is 8-10 minutes; and the method further includes a washing step after vacuum impregnation.

In some embodiments of the invention, in Step 2, the poly(sodium acrylate) solution has a concentration of 5 mol/L; the melamine resin foam with the cationic membrane coating is immersed in the poly(sodium acrylate) solution for 8-10 minutes at atmospheric pressure; and the method further includes a washing step after impregnation.

In some embodiments of the invention, in Step 3, the titanium dioxide mixed solution is a mixture of nano-titanium dioxide and sodium carboxymethyl cellulose; the concentration of nano-titanium dioxide in the mixed solution is 2-4 mg/mL; and the concentration of sodium carboxymethyl cellulose is 3-7 mg/mL.

In some embodiments of the invention, in Step 3, the cross-linking temperature is 20-30° C.; the cross-linking time is 1 hour; and the method further includes a washing step after cross-linking.

In some embodiments of the invention, Steps 1-3 use deionized water for washing.

In some embodiments of the invention, in Step 4, the trifluorooctyltriethoxysilane solution is prepared by adding trifluorooctyltriethoxysilane to ethanol.

In some embodiments of the invention, in Step 4, the concentration of the trifluorooctyltriethoxysilane solution is 5%-10%, with a more preferred range of 8%-10%.

In some embodiments of the invention, in Step 4, the cross-linked melamine resin foam is immersed in the trifluorooctyltriethoxysilane solution for 8-10 minutes; and after impregnation, the method includes drying at 40-60° C. for 6-8 hours.

Technical Solution 2: The hydrophobic melamine resin foam obtained using the preparation method described above.

Technical Solution 3: The application of the hydrophobic melamine resin foam described above in treating oil-containing wastewater.

The invention discloses the following technical effects:
1. Simple Preparation Method: The method provided is straightforward and cost-effective, making it suitable for large-scale industrial application.
2. Effective Hydrophobic Coating: The process involves vacuum-impregnating melamine resin foam in a poly(dimethyl diallyl ammonium chloride) solution, which coats the foam with a positively charged cationic film. Subsequent impregnation with a poly(sodium acrylate) solution deposits a negatively charged anionic film on top of the cationic layer. The interaction between the positive and negative charges enhances the adhesion of the anionic film within the foam's pores.
3. Stable Cross-Linking and Hydrophobic Modification: After applying the anionic film, the foam is immersed in a titanium dioxide mixed solution to achieve cross-linking, which secures titanium dioxide to the anionic film surface. Finally, further hydrophobic modification is achieved by impregnating the foam in a trifluorooctyltriethoxysilane solution.
4. High Hydrophobicity and Oil Absorption Performance: The resulting hydrophobic melamine resin foam achieves a high hydrophobic contact angle of up to 150°. Additionally, it exhibits excellent oil absorption properties, with oil absorption ratios of 50 or more for petroleum and 55 or more for tar.

### DETAILED DESCRIPTION OF EMBODIMENTS

Now, various exemplary embodiments of the present invention are described in detail. This detailed description should not be considered as limiting the present invention, but should be understood as a more detailed description of certain aspects, features and embodiments of the present invention.

It should be understood that the terms described in the present invention are only for describing specific embodiments and are not used to limit the present invention. In addition, for the numerical range in the present invention, it should be understood that each intermediate value between the upper and lower limits of the range is also specifically disclosed. The intermediate value in any stated value or stated range, and each smaller range between any other stated value or intermediate value in the stated range are also included in the present invention. The upper and lower limits of these smaller ranges may be independently included or excluded in the range.

Unless otherwise specified, all technical and scientific terms used herein have the same meanings as commonly understood by those skilled in the art in the field to which the present invention relates. Although the present invention describes only preferred methods and materials, any methods and materials similar or equivalent to those described herein may also be used in the implementation or testing of the present invention. All documents mentioned in this specification are incorporated by reference to disclose and describe the methods and/or materials related to the documents. In the event of a conflict with any incorporated document, the content of this specification shall prevail.

It is obvious to those skilled in the art that various modifications and changes may be made to the specific embodiments of the present invention description without departing from the scope or spirit of the present invention. Other embodiments obtained from the present invention description are obvious to the technician. The present invention description and embodiments are only exemplary.

The terms “include”, “including”, “have”, “contain”, etc. used in this article are open-ended terms, which means including but not limited to.

Testing methods for the invention are described as follows:

Water Contact Angle Test: This method uses a contact angle goniometer to measure the water contact angle of the sample, which characterizes its hydrophilic or hydrophobic properties.

Oil Absorption Ratio Test: Weigh a small piece of the hydrophobic melamine resin foam, noting the initial weight as M1. Immerse the foam in an oil-based liquid for 2 minutes. Remove the foam and let it drain naturally for 30 seconds until no more oil droplets fall. Weigh the foam again, noting the final weight as M2. Calculate the oil absorption ratio k using the formula:

k=(M2−M1)/M1

Materials and Reagents: Unless specified otherwise, all materials and reagents used in the embodiments are commercially available.

### Embodiment 1

Step 1: Wash the melamine resin foam with deionized water and dry it at 45° C. for 7.5 hours. After drying, vacuum-impregnate the foam in a 5 mol/L poly(dimethyl diallyl ammonium chloride) aqueous solution for 10 minutes. After vacuum impregnation, wash the foam with deionized water to obtain melamine resin foam coated with a cationic film.

Step 2: Place the cationic-coated melamine resin foam in a 5 mol/L poly(sodium acrylate) aqueous solution and vacuum-impregnate for 8 minutes. After impregnation, wash the foam with deionized water to obtain melamine resin foam coated with an anionic film.

Step 3: Prepare a titanium dioxide mixed solution by adding nano-titanium dioxide and carboxymethyl cellulose sodium to water. Adjust the pH of the solution to 7 with 1 mol/L HCl. Ultrasonicate the mixed solution for 4 hours, then stir at room temperature for 24 hours. The final concentrations are 3 mg/mL of nano-titanium dioxide and 5 mg/mL of carboxymethyl cellulose sodium.

Immerse the anionic-coated melamine resin foam in the titanium dioxide mixed solution at 25° C. for 1 hour for cross-linking. After cross-linking, wash the foam with deionized water to obtain the cross-linked melamine resin foam.

Step 4: Immerse the cross-linked melamine resin foam in an ethanol solution of 8% trifluorooctyltriethoxysilane for 8 minutes. After immersion, dry at 50° C. for 7 hours to obtain hydrophobic melamine resin foam. The hydrophobic melamine resin foam prepared in this embodiment has a water contact angle of 156.4°, with an oil absorption rate of 53.2 g/g for petroleum and 57.7 g/g for tar.

### Embodiment 2

Step 1: Wash the melamine resin foam with deionized water and then dry it at 40° C. for 8 hours. After drying, immerse the melamine resin foam in a 5 mol/L aqueous solution of poly(dimethyl diallyl ammonium chloride) for 8 minutes. After immersion, wash with deionized water to obtain melamine resin foam coated with a cationic membrane.

Step 2: Immerse the cationic membrane-coated melamine resin foam in a 5 mol/L aqueous solution of sodium polyacrylate under vacuum for 10 minutes. After immersion, wash with deionized water to obtain melamine resin foam coated with an anionic membrane.

Step 3: Add titanium dioxide nanoparticles and sodium carboxymethyl cellulose to water, adjust the pH of the solution to 7 with 1 mol/L HCl, and then sonicate the mixed solution for 4 hours. Stir at room temperature for 24 hours to obtain the titanium dioxide mixed solution. The concentration of titanium dioxide nanoparticles in the mixed solution is 2 mg/mL, and the concentration of sodium carboxymethyl cellulose is 3 mg/mL.

Immerse the anionic membrane-coated melamine resin foam in the titanium dioxide mixed solution at 30° C. for 1 hour for crosslinking. After crosslinking, wash with deionized water to obtain crosslinked melamine resin foam.

Step 4: Immerse the crosslinked melamine resin foam in an ethanol solution of 8% trifluorooctyltriethoxysilane for 10 minutes. After immersion, dry at 40° C. for 8 hours to obtain hydrophobic melamine resin foam.

The hydrophobic melamine resin foam prepared in this embodiment has a water contact angle of 150.2°, with an oil absorption rate of 50.1 g/g for petroleum and 55.3 g/g for tar.

### Embodiment 3

Step 1: Wash the melamine resin foam with deionized water and then dry it at 60° C. for 6 hours. After drying, immerse the melamine resin foam in a 5 mol/L aqueous solution of poly(dimethyl diallyl ammonium chloride) for 10 minutes. After immersion, wash with deionized water to obtain melamine resin foam coated with a cationic membrane.

Step 2: Immerse the cationic membrane-coated melamine resin foam in a 5 mol/L aqueous solution of sodium polyacrylate under vacuum for 10 minutes. After immersion, wash with deionized water to obtain melamine resin foam coated with an anionic membrane.

Step 3: Add titanium dioxide nanoparticles and sodium carboxymethyl cellulose to water, adjust the pH of the solution to 7 with 1 mol/L HCl, and then sonicate the mixed solution for 4 hours. Stir at room temperature for 24 hours to obtain the titanium dioxide mixed solution. The concentration of titanium dioxide nanoparticles in the mixed solution is 4 mg/mL, and the concentration of sodium carboxymethyl cellulose is 7 mg/mL.

Immerse the anionic membrane-coated melamine resin foam in the titanium dioxide mixed solution at 30° C. for 1 hour for crosslinking. After crosslinking, wash with deionized water to obtain crosslinked melamine resin foam.

Step 4: Immerse the crosslinked melamine resin foam in an ethanol solution of 10% trifluorooctyltriethoxysilane for 10 minutes. After immersion, dry at 40° C. for 8 hours to obtain hydrophobic melamine resin foam.

The hydrophobic melamine resin foam prepared in this embodiment has a water contact angle of 159.8°, with an oil absorption rate of 55.9 g/g for petroleum and 59.6 g/g for tar.

The embodiments described above are only descriptions of the preferred modes of the present invention, and are not intended to limit the scope of the present invention. Without departing from the design spirit of the present invention, various modifications and improvements made to the technical solutions of the present invention by ordinary technicians in this field should all fall within the protection scope determined by the claims of the present invention.

What is claimed is:

1. A method for preparing hydrophobic melamine resin foam, comprising the following steps: step 1: vacuum-impregnate melamine resin foam in a solution of poly(dimethyl diallyl ammonium chloride) to obtain melamine resin foam coated with a cationic membrane; step 2: immerse the cationic-coated melamine resin foam in a solution of sodium polyacrylate to obtain melamine resin foam coated with an anionic membrane; step 3: immerse the anionic-coated melamine resin foam in a titanium dioxide mixed solution for cross-linking to obtain cross-linked melamine resin foam; step 4: immerse the cross-linked melamine resin foam in a solution of tridecafluoro-octyl triethoxysilane, then dry the foam after impregnation to obtain the hydrophobic melamine resin foam.

2. The preparation method of hydrophobic melamine resin foam, as claimed in claim 1, wherein in step 1, the poly(dimethyl diallyl ammonium chloride) solution has a concentration of 5 mol/L; the vacuum impregnation time is 8-10 minutes; and the process further includes a washing step after vacuum impregnation.

3. The preparation method of hydrophobic melamine resin foam as claimed in claim 1, wherein in step 2, the sodium polyacrylate solution has a concentration of 5 mol/L; the impregnation time is 8-10 minutes at atmospheric pressure; and the process further includes a washing step after impregnation.

4. The preparation method of hydrophobic melamine resin foam as claimed in claim 1, wherein in step 3, the titanium dioxide mixed solution is a mixed aqueous solution of nano-titanium dioxide and sodium carboxymethyl cellulose; the concentration of nano-titanium dioxide in the mixed solution is 2-4 mg/mL; and the concentration of sodium carboxymethyl cellulose in the mixed solution is 3-7 mg/mL.

5. The preparation method of hydrophobic melamine resin foam as claimed in claim 1, wherein in step 3, the cross-linking temperature is 20-30° ;. the cross-linking time is 1 hour; and the process further includes a washing step after cross-linking.

6. The preparation method of hydrophobic melamine resin foam as claimed in claim 1, wherein in step 4, the tridecafluoro-octyl triethoxysilane solution is prepared by adding tridecafluoro-octyl triethoxysilane to ethanol; the mass concentration of the tridecafluoro-octyl triethoxysilane solution is 5%-10%; the impregnation time of the cross-linked melamine resin foam in the tridecafluoro-octyl triethoxysilane solution is 8-10 minutes; and the process further includes a drying step at 40-60° C. for 6-8 hours after impregnation.

7. A hydrophobic melamine resin foam obtained by the preparation method of claim 1.

8. An application of the hydrophobic melamine resin foam in treating oil-containing wastewater as claimed in claim 7.
